(19) United States
(12) Patent Application Publication
(10) Pub. No.: US 2024/0116748 A1
(43) Pub. Date: Apr. 11, 2024

(54) Combination Modular Riding and Pack Saddle and Methods for Manufacturing the Same

(71) Applicant: Mark Thompson, Providence, UT (US)

(72) Inventor: Mark Thompson, Providence, UT (US)

(21) Appl. No.: 18/130,747

(22) Filed: Apr. 4, 2023

Related U.S. Application Data
(60) Provisional application No. 63/414,261, filed on Oct. 7, 2022.

(51) Int. Cl. B68C 1/04

(52) U.S. Cl. CPC B68C 1/04; B68C 2001/044

(57) ABSTRACT

A horse saddle with a frame and a body. The frame may be a metal bar and the body may be rotationally molded, over molded or utilize other manufacturing techniques to at least partially enclose the frame in the body, and the exposed portions of the frame functioning as D-rings for rigging loads to the saddle. The saddle functions both for riding, packing or both riding and packing. The saddle may include a metal of a first material and a body of a second material. The body may be mostly hollow and be lightweight with improved comfort resulting from depressions in the saddle seat.

### CROSS-REFERENCE TO RELATED APPLICATIONS

This application claim priority to provisional patent application No. 63/414,261 filed Oct. 7, 2023.

### TECHNICAL FIELD

The present disclosure relates generally to horse saddles. More particularly, the disclosure relates to an improved light-weight combination riding saddle and pack saddle with sit-bone recesses for improved comfort.

### BACKGROUND

People have used saddles to ride animals for thousands of years. The saddle is a supportive structure for a rider of an animal, fastened to an animal's back by a girth. The most common type is the equestrian saddle designed for a horse. The solid saddle tree was a later invention, and though early stirrup designs predated the invention of the solid tree, the paired stirrup, which attached to the tree, was the last element of the saddle to reach the basic form that is still used today. Today, modern saddles come in a wide variety of styles, each designed for a specific equestrianism discipline, and require careful fit to both the rider and the horse. Proper saddle care can extend the useful life of a saddle, often for decades. The saddle was a crucial step in the increased use of domesticated animals.

The saddle tree is the base on which the rest of the saddle is built—usually based on wood or a similar synthetic material. The saddler eventually covers it with leather or with a leather-like synthetic. The tree's size determines its fit on the horse's back, as well as the size of the seat for the rider. It provides a bearing surface to protect the horse from the weight of the rider. The solid saddle tree raises the rider above the horse's back, and distributes the rider's weight, reducing the pounds per square inch carried on any one part of the horse's back, thus greatly increasing the comfort of the horse and prolonging its useful life.

The saddle seat is the part of the saddle where the rider sits, it is usually lower than the pommel and cantle to provide security. The pommel or swells is the front, slightly raised area of the saddle. The cantle is the rear of the saddle. Saddle dee or D-ring is a “D”-shaped ring on the front of a saddle, to which certain pieces of equipment (such as breastplates) can be attached.

The McClellan saddle design was based on the Spanish tree saddles in wide use in the United States at the time of the Civil War and is very close to the widely used Spanish tree saddle, which was originally a saddle in common use in Mexico. The design underwent modifications over time, although in many ways it remained remarkably unchanged. The saddle was simple and less expensive than existing saddles, light enough not to burden the horse, but sturdy enough to give good support to the rider and his gear. It supported a rawhide-covered open seat, a thick leather skirt, wooden stirrups, and a girth strap of woolen yarn. Added accessories to the saddle sometimes included a nose bag for horse feed, a curry comb to groom the horse, a picket pin and lariat to tether the horse while grazing, saddlebags, and a “thimble” that held the muzzle of the cavalryman's carbine. The McClellan saddle was placed on top of a saddlecloth, shabrack, or saddle blanket.

Another type of saddle is a pack saddle, a device designed to be secured on the back of a horse, mule, or other working animal so it can carry heavy loads such as luggage, firewood, small cannons, or other things too heavy to be carried by humans. Normally a pack saddle is not used by a rider to mount the animal. The pack saddle consists of a tree, or the wooden blocks that sit on the horse's back, the half breed, which is the canvas saddle cover, the breeching and often a crupper which prevents the loaded saddle from sliding too far forward and the breast collar which holds the loaded saddle from sliding too far back on the packhorse or mule. The flexible bars on this packsaddle adjust to a horse's back and offer several options for hanging panniers, manties (packs wrapped in canvas), or other loads.

Pack saddles and riding saddles are two different saddles and are not generally interchangeable. For example, a hunter may use a riding saddle to ride his or her horse into the backcountry, harvest game and need to use a pack saddle so the horse can carry the game out. Current saddles are not conducive to both. Thus, a need exists for a saddle that can serve as both a riding saddle and a pack saddle.

Current saddle manufacturing techniques pose further limitations. A need exists for a modular saddle system to improve manufacturing efficiencies.

Current saddle weights also pose limitations. A need exists for a lightweight saddle that is rigid enough to carry a load without deforming and comfortable enough to function as a riding saddle.

No matter which saddle style used, the ischium or “sitz bones” is the first contact between the rider and the saddle. Current saddles pinch the muscle and skin between the ischium and the saddle making long rides uncomfortable, particularly for novice riders.

Despite the diversity in saddles, there exists a need for a saddle with improved comfort, lighter weight and improved performance both as a riding saddle and a pack saddle, utilizing improved manufacturing techniques and materials.

### BRIEF SUMMARY

The general purpose of the systems and methods disclosed herein is to provide an improved saddle, while also promoting efficiencies in manufacturing and improved saddle performance. Specifically, the saddle taught herein is lighter weight compared to traditional saddles, improves riding comfort and functions as both a riding saddle and a pack saddle.

In one non-limiting embodiment, a saddle system configured to support a load is taught. One general aspect includes supporting both a rider and a pack load. The saddle also includes a frame and a body enclosing at least a portion of the frame. Other embodiments of this aspect include corresponding tack such as leather flaps, stirrups, crupper, breast collar, surcingle, and other apparatus each configured to perform the actions of the methods.

Implementations may include one or more of the following features. The saddle where the frame may include metal tubing. The frame may include a first shaped bar and a second shaped bar. The shell, or skin or body enclosing the frame may form a hollow shell around the frame. The body may be rotomolded. The body may be over-molded or co-molded. The body may include lacuna or recesses formed in a seat of the saddle and configured to receive a rider's ischium or sitz bones. The body may include a rotomolded skin. The frame may include a first tubing configured to support a pommel and knee-roll and a second set of tubing configured to form support a cantle. A portion of the frame may include a rigging dee.

The body may be modular. The body may be a core component of a saddle which may be augmented by other modular parts. The body may further include modular features such as a selectively-removable saddle horn, selectively removable packing rigs. The body may be in various states of completion, from raw plastic skin to finished leather overlaying the body.

One general aspect includes a method of manufacturing a saddle. The method of manufacturing may include forming a tubular frame into a saddle tree. The method may also include encasing at least a portion of the tubular frame in a body. The method may include rotationally molding the body around the tubular frame 130. The method may include overmolding the body around the tubular frame 140. The method may include forming lacuna into the body. The method may include customizing the saddle by sizing and positioning the lacuna based on custom measurements taken from a specific rider. The method may include customizing the saddle by forming the lacuna based on custom measurements taken from a specific rider. Other embodiments of this aspect include corresponding structure configured to perform the actions of the methods.

### BRIEF DESCRIPTION OF THE DRAWINGS

In order to describe the manner in which the advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A shows a transparent view of the saddle frame and body.

FIG. 1B shows an alternate transparent top view of the saddle frame and body.

FIG. 1C shows an alternate transparent front view of the saddle frame and body.

FIG. 1D shows an alternate transparent side view of the saddle frame and body.

FIG. 2A shows the saddle mounted on a horse.

FIG. 2B shows the front of the saddle with a rider sitting on the saddle.

FIG. 2C shows the rear of the saddle with a rider sitting on the saddle.

FIG. 2D shows the saddle mounted on a horse supporting a rider.

FIG. 3 shows the saddle and a selectively removable saddle horn.

FIG. 4A shows the saddle and a selectively removable saddle packing rig engaged in saddle frame.

FIG. 4B shows the saddle and a selectively removable saddle packing rig disengaged from saddle frame.

FIG. 4C shows a profile view of the packing rig.

FIG. 4D shows the saddle with the packing rig engaged with the saddle mounted on a horse.

FIG. 4E shows the saddle with the packing rig engaged with the saddle mounted on a horse and haul bags hanging from the packing rig.

FIG. 5 shows a method of making a modular saddle.

### DETAILED DESCRIPTION OF THE INVENTION

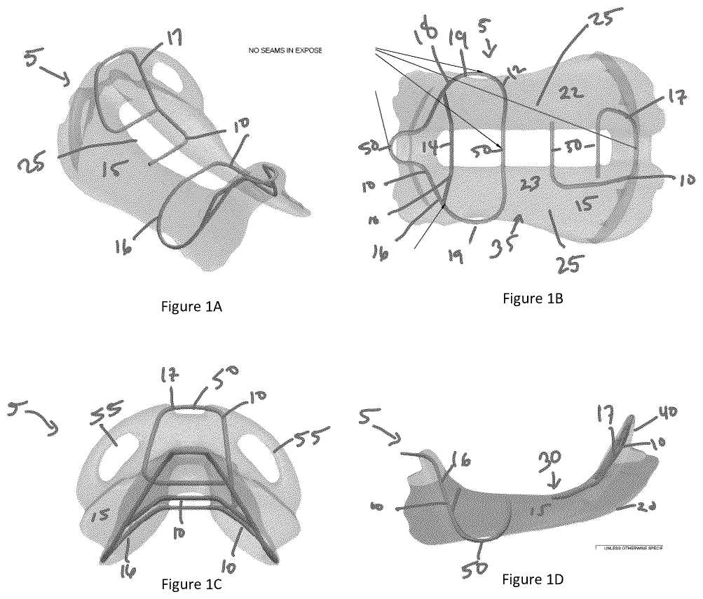

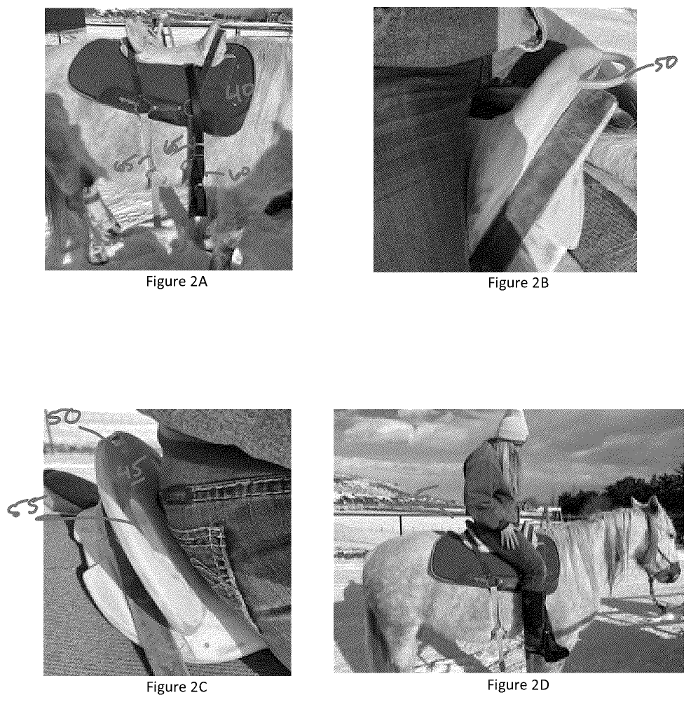

The present embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed descriptions of the embodiments of the apparatus, as represented in FIGS. 1A through 2D are not intended to limit the scope of the invention, as claimed, but are merely representative of present embodiments of the invention.

In general, the figures disclose an invention that provides a combination riding saddle and pack saddle comprising an internal frame and an external cover. In some embodiments the frame comprises a seat and rigging dee rings to which a load may be tied, allowing the saddle to serve as a riding saddle, a pack saddle or both a riding saddle and pack saddle. In some embodiments the dee rings are streamlined into the body. In some embodiments the saddle comprises a body which forms the saddle seat. In some embodiments the frame and the body may be a different material. In some embodiments the frame may be metal while the body may be a polymer. In some embodiments the body is rotomolded, thus forming a hollow shell at least partially enclosing the frame. In some embodiments the body is over molded or comolded to the frame. In some embodiments recesses in the saddle seat are sized and positioned to receive a rider's sitz bones, thus reducing the pressure and pain caused by long rides by dispersing the rider's weight over a larger area of rider's posterior and legs.

In the following description, numerous references will be made to horses used as pack animals or equestrian activities. However, it should be understood that one of ordinary skill in the art and in possession of this disclosure, would readily understand how the present invention can be used with any riding activity structures.

Detailed references will now be made to the preferred embodiments of the present invention, examples of which are shown in FIGS. 1A-2D, illustrate various views of a saddle in accordance with one or more embodiments of the invention.

Implementations may include one or more of the following features. Some embodiments comprise a saddle 5. In some embodiments the saddle 5 further comprises a frame 10. In some embodiments the frame may include metal tubing 10.

In some embodiments the tubing is hollow tubing. In some embodiments the tubing is solid tubing. In some embodiments a combination of hollow tubing and solid tubing is used to achieve the desired mechanical properties of strength, weight and flexibility. The frame 10 may be welded together to optimize mechanical properties. In some embodiments the frame may comprise hollow tubing to form support for a rider while using solid tubing for the dee rings 50. In some embodiments the frame 10 may provide attachment points for the saddle cinches 60 and 65.

In some embodiments the frame 10 may comprise material that is more workable to fit a specific horse. In some embodiments the frame may comprise materials made of advanced composites such as carbon fiber or ceramic materials to minimize weight, improve comfort for the animal or accommodate the needs of a specific rider based on weight, size or disability.

In some embodiments the frame may include a first shaped bar 16. In some embodiments the frame may comprise a second shaped bar 17. In some embodiments the first shaped bar and the second shaped bar are a single continuous bar. In some embodiments the first shaped bar and the second shaped bar are two separate pieces. In some embodiments the first shaped bar is configured to distribute the saddle load across the animal. In some embodiments the frame comprises a hoop portion 18 which extends to the periphery of the saddle. In some embodiments the hoop portion 18 is and are exposed to form rigging rings 19 to which stirrup straps can be fastened. In some embodiments the hoop portion is exposed on the pommel 21. In some embodiments the hoop portion is exposed between the first side bar 22 and the second side bar 23.

In some embodiments the body comprises a hollow shell 20 formed around the frame 10. In some embodiments the hollow shell 20 is rotomolded around the frame 10. In some embodiments the body 15 may include a rotomolded skin 35. In some embodiments the body may comprise an over-molding at least partially enclosing the frame 10.

In some embodiments the body 15 may include indentations, recessions, depressions or lacuna 25 formed in a seat 30 of the saddle 5 and configured to receive the sitz bones or ischium of a rider. In some embodiments the lacuna are molded into the surface of the seat 30. In some embodiments the lacuna 25 are machined into the surface seat 30. In some embodiments the lacuna are positioned based on the measurements of the rider who will utilize the saddle. In some embodiments the lacuna are positioned based on the gender of the rider, ie saddles for men and saddles for women. In some embodiments the lacuna are sized based on general rider size, such as small, medium and large. In some embodiments the lacuna are a flattened distal portion of each side bar 22, 23 extending to medial gap between the side bars forming the seat 30, thus distributing the weight of the rider away from the sitz bones and to the rider's buttocks and legs.

In some embodiments the frame 10 may include a first member or tubing configured to distribute the weight of the load, such as a rider, a pack load or both, across the back of the animal. In some embodiments the first tubing is the first shaped bar 16 and functions as a saddle tree skeleton. In some embodiments the first shaped bar 16 is configured to support the knee-roll 40. In some embodiments the first shaped bar 16 is configured to support the pommel. In some embodiments a plurality of sections of the first shaped bar 16 may be exposed through the body. In some embodiments a section of the first shaped bar 16 is exposed in a gap formed between the first side bar 22 and the second side bar 23.

In some embodiments the second shaped bar 17 is configured to support a cantle 45. In some embodiments the exposed portion of the frame 10 on the cantle may include a rigging dee 50. In some embodiments a plurality of sections of the second shaped bar 17 may be exposed through the body.

In some embodiments the frame 10 may include a first material and the body 15 may include a second material. In some embodiments the body 15 that encloses at least a portion of the frame.

Implementations may include one or more of the following features. In some embodiments the saddle where the body is hollow 20. In some embodiments the frame may include a metal bar 12 disposed within the hollow body 20. In some embodiments the body may include a seat 30 may include at least a first lacuna 25 in the seat 30 configured to receive a rider's sit bones.

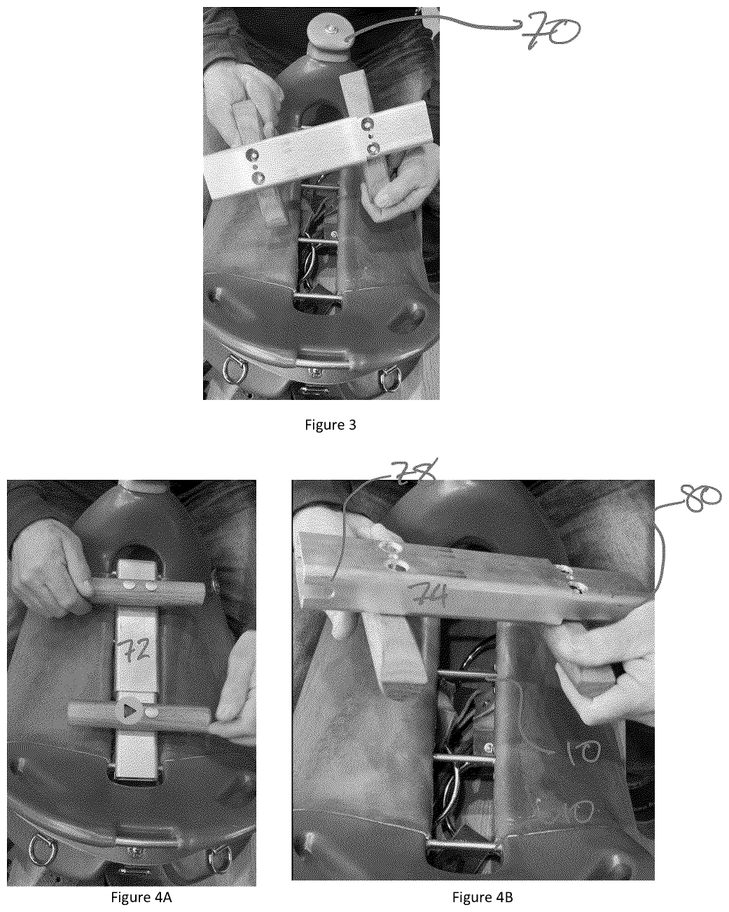

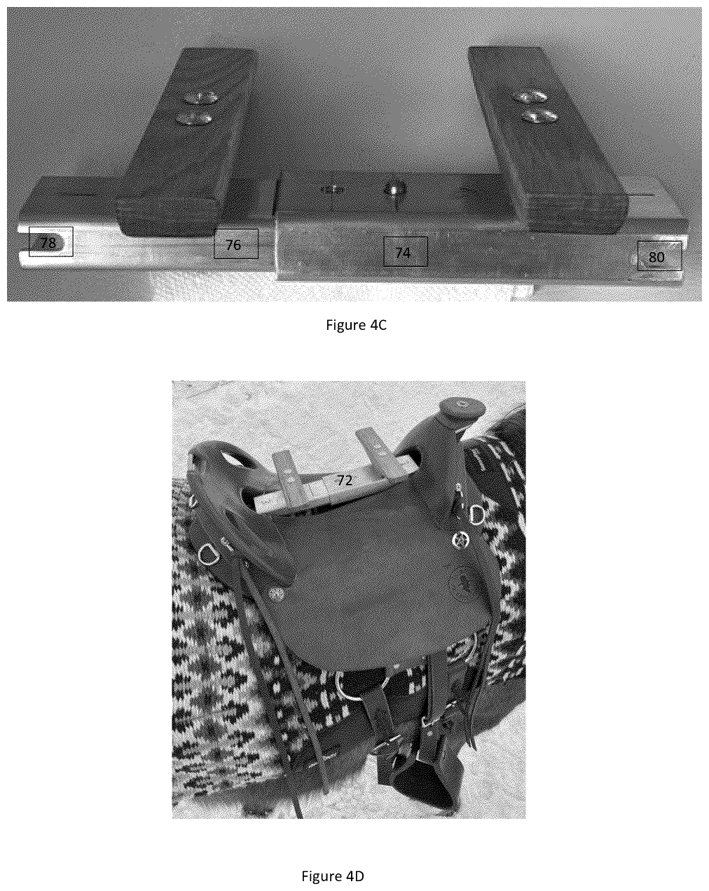

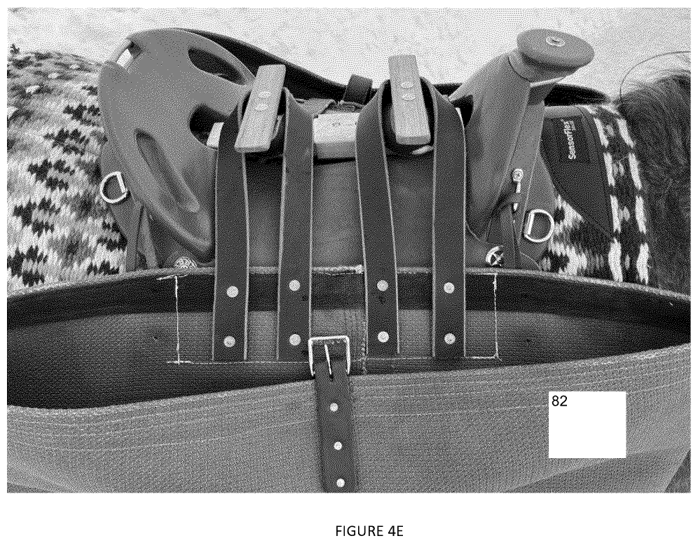

Referring now to FIGS. 3 and 4, some embodiments comprise modular saddle elements and features. In some embodiments the frame 10 may be formed without a saddle horn 70. In some embodiments a saddle horn 70 may be selectively coupled to the saddle. In some embodiments the saddle horn may be screwed into a threaded receiver in the saddle pommel. In some embodiments the saddle may be clamped to the frame 10. In some embodiments the saddle horn 70 may be permanently attached to the saddle during a secondary manufacturing phase after the formation of the body 15.

Referring now to FIGS. 4A-4E, some embodiments comprise packing rig 72. In some embodiments the packing rig 72 may comprise a bar comprising rigging cleats. In some embodiments the packing rig 72 is selectively couplable to the frame. In some embodiments the packing rig 72 comprises a first sleave 74 and a second sleave 76 wherein the first sleave slidably nests within the second sleave. In some embodiments the packing rig 72 further comprises a notch 78 on the distal end of the first sleave and a notch 80 on the distal end of the second sleave. In some embodiments the packing rig 72 is placed so that the notches at the distal ends of the sleaves engage the frame 10 so as to secure the packing rig to the saddle. In some embodiments the placement of the packing rig converts the saddle from a riding saddle to a pack saddle. In some embodiments the packing rig 72 comprises a locking mechanism that locks the rig in an extended position or in a contracted position. In some embodiments a haul bag 82 engages the packing rig 72 to allow the haul bag to carry a load. In some embodiments a load is tied directly to the packing rig 72. In some embodiments the packing rig 72 may be integrated into the saddle in the space between the surface of the saddle that engages the rider and the surface of the saddle that abuts the animal or a saddle blanket.

In some embodiments the packing rig may comprise a folding mechanism wherein the packing rig has a first position folded inside the saddle and a second unfolded position extended outside the saddle. In some embodiments the cleats extending from the top of the packing rig 72 twist and the packing rig folds into the gap formed in the saddle.

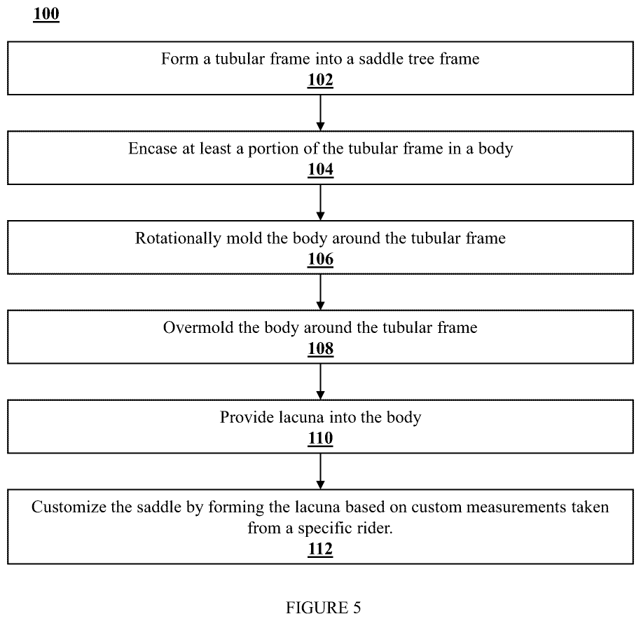

Referring now to FIG. 5, one general aspect includes a method of manufacturing a saddle 100. A method of manufacturing a saddle comprises forming a frame into a saddle tree frame. 102 Some embodiments comprise enclosing at least a portion of the frame in a body. 104 Some embodiments comprise rotationally molding the body around the frame. 106 Some embodiments comprise overmolding the body around the frame. 108 Some embodiments comprise providing lacuna into the body. 110 Some embodiments comprise customizing the saddle by forming the lacuna based on custom measurements taken from a specific rider. 112

In some embodiments the method of manufacturing the saddle also includes forming a frame into a saddle frame. In some embodiments the method of manufacturing a saddle further comprises a molding a body to at least partially encase the frame 115. Some embodiments further comprise exposing at least a portion of the frame. Some embodiments comprise encasing at least a portion of the tubular frame in the body.

Some embodiments further comprise rotationally molding the body around the frame 120. Some comprise over molding the body around the frame 125. Some embodiments comprise forming lacuna into the body 130. Some embodiments comprise customizing the saddle by forming the lacuna based on custom measurements taken from a specific rider 135.

In some embodiments the modular saddle is manufactured in stages. An alternative embodiment comprises shaping the frame to provide the desired saddle shape. In an alternative embodiment a stage comprises forming a body by at least partially encasing a frame. In an alternative embodiment a stage comprises covering the body with a covering. In an alternative embodiment a stage comprises augmenting the body with modular features comprising a saddle horn. In an alternative embodiment a stage comprises augmenting the body with a modular feature comprising a packing rig. In an alternative embodiment a stage comprises customizing or processing the body to form indentations or recesses to receive sitz bones of a specific measurement.

In closing, it is to be understood that the embodiments of the disclosure disclosed herein are illustrative of the principles of the present disclosure. Other modifications that may be employed are within the scope of the disclosure. Thus, by way of example, but not of limitation, alternative configurations of the present disclosure may be utilized in accordance with the teachings herein. Accordingly, the present disclosure is not limited to that precisely as shown and described.

1. A saddle comprising:
a frame; and
a body wherein the frame is at least partially enclosed in the body.

2. The saddle of claim 1 wherein the frame comprises metal tubing.

3. The saddle of claim 1 wherein the frame comprises a first shaped bar and a second shaped bar.

4. The saddle of claim 1 wherein the body comprises a polymer.

5. The saddle of claim 1 wherein the body forms a hollow shell around the frame.

6. The saddle of claim 5 wherein the hollow shell is over molded around the frame.

7. The saddle of claim 1 wherein the body comprises a lacuna in a seat of the saddle and configured to receive an ischium of a rider.

8. The saddle of claim 1 wherein the saddle further comprises a first side bar and a second side bar wherein the frame is exposed in a gap formed between a first side bar and a second side bar.

9. The saddle of claim 1 wherein the frame comprises a first tubing configured to support a pommel and a second set of tubing configured to form support a cantle.

10. The saddle of claim 9 wherein the first tubing comprises a hoop portion wherein a medial section of the hoop portion comprising the pommel is exposed forming a rigging dee.

11. The saddle of claim 1 wherein the portion of the frame comprises a rigging dee.

12. A saddle comprising:
a frame comprising a first material; and
a body comprising a second material that encloses at least a portion of the frame.

13. The saddle of claim 12 wherein the body is hollow.

14. The saddle of claim 12 wherein the frame comprises a metal tube.

15. The saddle of claim 12 wherein the body comprises a seat further comprising at least a first lacuna in the seat configured to receive a rider's sit bones.

16. A method of manufacturing a saddle comprising:
forming a frame into a saddle tree frame; and
enclosing at least a portion of the frame in a body.

17. The method of claim 16 further comprising rotationally molding the body around the frame.

18. The method of claim 16 further comprising over molding the body around the frame.

19. The method of claim 16 further comprising molding lacuna into the body.

20. The method of claim 19 further comprising customizing the saddle by forming the lacuna based on custom measurements taken from a specific rider.
